(19) United States
(12) Patent Application Publication
(10) Pub. No.: US 2023/0310918 A1
(43) Pub. Date: Oct. 5, 2023

(54) FLUORINE-FREE FIREFIGHTING FOAMS FOR USE IN SPRINKLERS

(71) Applicant: PERIMETER SOLUTIONS LP, Clayton, MO (US)

(72) Inventors: LeiLei Zhang, Green Bay, WI (US); Pamela Havelka-Rivard, De Pere, WI (US); Aaron Donovan, Green Bay, WI (US); Covadonga Perez, Mieres (ES)

(21) Appl. No.: 18/130,482

(22) Filed: Apr. 4, 2023

Related U.S. Application Data
(60) Provisional application No. 63/327,198, filed on Apr. 4, 2022.

(51) Int. Cl. A62D 1/02

(52) U.S. Cl. CPC A62D 1/0071

(57) ABSTRACT

The present invention is directed to fluorine-free firefighting foam concentrates containing one or more solvents, one or more surfactants, one or more alcohols, and one or more biopolymers. The present invention is also directed to firefighting foam solutions and firefighting foams prepared from such concentrates and methods for their use. The present invention is also directed to methods for controlling the viscosity of firefighting foam concentrates, including lowering of the concentrate viscosity as temperature decreases.

### REFERENCE TO RELATED APPLICATIONS

This application claims the benefit of and priority to U.S. Provisional Patent Application Ser. No. 63/327,198, filed Apr. 4, 2022, the entire contents of which are hereby incorporated by reference.

### FIELD OF THE INVENTION

The present invention is directed to fluorine-free firefighting foam concentrates containing one or more solvents, one or more surfactants, one or more alcohols, and one or more biopolymers. The present invention is also directed to firefighting foam solutions and firefighting foams prepared from such concentrates and methods for their use. The present invention is also directed to methods for controlling the viscosity of firefighting foam concentrates, including lowering of the concentrate viscosity as temperature decreases.

### BACKGROUND OF THE INVENTION

Aqueous firefighting foams are used against Class B fires (i.e., fires fueled by flammable liquids). Such firefighting foams include both aqueous film-forming foams (AFFF) and alcohol-resistant aqueous film-forming foams (AR-AFFF). In recent years, due to toxicity concerns fluorine-free aqueous firefighting foams have been developed. Suitable fluorine-free foams have been developed. But opportunities exist for improvements in certain properties of the foams to provide enhanced performance. One property is use in all available sprinkler heads, including non-aspirated sprinkler heads. Another property is the suitability of the concentrates for cold temperature proportioning.

### BRIEF SUMMARY OF THE INVENTION

Briefly, therefore the present invention is directed to firefighting foam concentrates comprising: one or more organic solvents, wherein the one or more organic solvents are selected from the group consisting of propylene glycol, glycerin, ethylene glycol, butyl carbitol, propylene glycol n-butyl ether (PnB), butyl glycol, polyethylene glycol, hexylene glycol, and combinations thereof; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, and combinations thereof; one or more alcohols; and one or more biopolymers, wherein the biopolymers constitute from about 0.2 wt % to about 20 wt % of the concentrate, and wherein the one or more solvents are selected to provide a heat thickening concentrate.

The present invention is also directed to firefighting foam concentrates comprising: one or more organic solvents, wherein the one or more organic solvents comprise one or more glycols and one or more glycol ethers; one or more surfactants, wherein the one or more surfactants comprise a C8-C22 sulfonate surfactant and/or a C8-C22 sulfate surfactant, a branched and/or linear ethoxylated sulfate C8-C16 sulfate surfactant, a C8-C22 betaine surfactant, and a C8-C22 sultaine surfactant; one or more alcohols; and one or more polymers, wherein the polymers constitute from about 0.2 wt % to about 2.0 wt % of the concentrate.

The present invention is further directed to firefighting foam concentrates comprising: one or more organic solvents, wherein the one or more organic solvents comprise one or more glycols and one or more glycol ethers; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, and combinations thereof; one or more alcohols, wherein the one or more alcohols comprise at least one branched C10-C16 alcohol and the at least one branched C10-C16 alcohol constitutes from about 0.3 wt % to about 2.5 wt % of the concentrate; and one or more polymers, wherein the polymers constitute from about 0.2 wt % to about 2.0 wt % of the concentrate.

The present invention is still further directed to firefighting foam concentrates comprising: one or more organic solvents, wherein the one or more organic solvents are selected from the group consisting of propylene glycol, glycerin, ethylene glycol, butyl carbitol, propylene glycol n-butyl ether (PnB), butyl glycol, polyethylene glycol, hexylene glycol, and combinations thereof; one or more surfactants, wherein the one or more surfactants comprise a C8-C22 sulfonate surfactant or a C8-C22 sulfate surfactant, a branched and/or linear ethoxylated sulfate C8-C16 sulfate surfactants, a C8-C22 betaine surfactant, and a C8-C22 sultaine surfactant; one or more alcohols; and one or more biopolymers, wherein the one or more biopolymers are selected from the group consisting of diutan gum, xanthan, guar gum, welan gum, gellan gum, and combinations thereof, and wherein the concentrate passes the cold temperature proportioning (CTP) test.

The present invention is still further directed to firefighting foam solution compositions prepared by diluting concentrates of the present invention with water.

The present invention is also directed to firefighting foam composition prepared from the concentrates and solutions of the present invention, wherein the foam composition is suitable for use in aspirated and non-aspirated sprinkler heads; and/or meets FM standard 5130 for commercial/industrial applications; and/or meets both FM and UL standards for commercial/industrial applications; and/or passes UL and/or FM topside polar and nonpolar fire tests; and/or meets all stability requirements; and/or meets all sprinkler fire test requirements

The present invention is also directed to methods for controlling the viscosity of firefighting foam concentrates. In certain embodiments, the method comprises: providing a foam concentrate of the present invention; subjecting the foam concentrate to cold temperature proportioning (CTP) testing; determining whether the CTP testing results are above or below 85%; and if the CTP testing results are below 85% adjusting the one or more solvents of the foam concentrate, wherein said adjusting comprises: removing one or more of the solvents, adjusting the concentration of one or more of the solvents, and/or adding one or more solvents to the concentrate; and/or adding a short chain surfactant to the concentrate, wherein the short chain surfactant is selected from the group consisting of short chain sulfonate/sulfate surfactants, short chain branched and linear ethoxylated sulfate surfactants, short chain betaine surfactants, short chain sultaine surfactants, and combinations thereof; and/or adjusting the one or more alcohols, wherein said adjusting comprises removing the one or more alcohols and introducing one or more added alcohols, wherein the one or more added alcohols are different from the one or more alcohols and are selected from the group consisting of a C8-C16 linear alcohol, a C10-C16 branched alcohol, or a combination thereof.

The present invention is further directed to industry-approved (i.e., Underwriters Laboratory (UL) listed and/or Factory Mutual (FM) approved), fluorine-free, 3×3 foam concentrate for use in multi-head sprinkler systems.

In various of the above embodiments and other embodiments described herein, the composition further comprises water.

The present invention is further directed to methods for suppressing and/or extinguishing a Class-B fire.

Other objects and features will be in part apparent and in part pointed out hereinafter.

### BRIEF DESCRIPTION OF THE FIGURES

FIGS. 1A, 1B, and 1C display, respectively, the effects of different alcohols on (a) foam expansion volume out of 100 g 3% solution, (b) foam 30% drain time, and (c) foam stability on IPA for Formulation 5 in Example 1.

FIG. 2 displays a graph of viscosity versus temperature for an initial solvent and for a solvent-blend that provided a Formulation passing the cold temperature proportioning (CTP) testing as described in Example 2.

FIGS. 3A and 3B show the results of converting a heat-thinning foam concentrate to a heat-thickening foam concentrate by adding short chain surfactants and changing the alcohol structure, respectively.

FIG. 4 displays a proposed mechanism for modifying the foam concentrate flow properties as descried in the Examples.

### DETAILED DESCRIPTION OF THE INVENTION

Described herein are fluorine-fire firefighting foam concentrates that exhibit one or more advantageous properties and that provide foam solutions and foam compositions exhibiting one or more advantageous properties. One advantageous property of the present compositions is suitability for use with all types of sprinkler heads, including aspirated and non-aspirated sprinkler heads and in multi-sprinkler systems. Also, the concentrates of the present invention exhibit advantageous behavior when subjected to cold temperature proportioning (CTP) testing. Overall, the compositions of the present invention are suitable for meeting industry standards, including Underwriters Laboratory (UL) listing and Factory Mutual (FM) approval standards for commercial and/or industrial applications. These advantageous properties are provided by various combinations of the components detailed herein and described in the appended claims. The present invention is also directed to methods for controlling the viscosity of foam concentrates, including providing reduced concentrate viscosity at lower temperatures.

Generally, the compositions of the present invention include one or more organic solvents, one or more surfactants, one or more alcohols, and one or more biopolymers.

Organic Solvent(s)

Suitable organic solvents include alkyl glycols, polyols, and glycol ethers. Exemplary alkyl glycol diols include propylene glycol, butyl glycol, neopentyl glycol, hexylene glycol, ethylene glycol, 2-methyl-2,4-pentanediol, and combinations thereof. In accordance with certain embodiments, the organic solvent is an alkyl glycol diol selected from propylene glycol, butyl glycol, ethylene glycol, and combinations thereof. In certain embodiments, the organic solvent is butyl glycol. In still further embodiments, the organic solvent is an alky glycol triol including, for example, glycerin.

Further in accordance with the present invention, the organic solvent may be a glycol ether. Suitable glycol ethers include propylene, n-butyl glycol ether, dipropylene glycol n-propyl ether, dipropylene glycol n-butyl ether, propylene glycol n-butyl ether (PNB), propylene glycol n-propyl ether, tripropylene glycol n-butyl ether, propylene glycol phenyl ether, dipropylene glycol phenyl ether, dipropylene glycol dimethyl ether, propylene glycol methyl ether, propylene glycol methyl ether acetate, dipropylene glycol methyl ether, dipropylene glycol methyl ether acetate, tripropylene glycol methyl ether, ethylene glycol hexyl ether; diethylene glycol hexyl ether; ethylene glycol propyl ether; diethylene glycol phenyl ether, ethylene glycol phenyl ether, poly(oxy-1,2-ethanediyl), alphaphenyl-omegahydroxy, diethylene glycol ethyl ether, diethylene glycol n-butyl ether, ethylene glycol n-butyl ether, butyl carbitol, and combinations thereof. In certain embodiments, the glycol ether is selected from the group consisting of propylene glycol, n-butyl glycol ether, butyl glycol, butyl carbitol, and combinations thereof.

In various embodiments, the organic solvent is selected from the group consisting of alcohols, diols (e.g., glycols), glycol ethers, and combinations thereof. In certain embodiments, the compositions include one, two or three organic solvents.

In particular, in certain embodiments the composition includes one, two, or three glycol and/or glycol ether solvents. In various embodiments, the composition comprises a glycol solvent and a glycol ether solvent. In various other embodiments, the composition comprises a plurality of glycol ether solvents (e.g., two, or three glycol ether solvents).

In various embodiments, the one or more organic solvents are selected from the group consisting of propylene glycol, glycerin, ethylene glycol, butyl carbitol, propylene glycol n-butyl ether (PnB), butyl glycol, polyethylene glycol, hexylene glycol, and combinations thereof.

In various other embodiments, the organic solvent(s) can include one or more of propylene glycol, hexylene glycol, butyl carbitol, propylene glycol n-butyl ether (PnB), and/or butyl glycol. In certain embodiments the one or more organic solvents comprise hexylene glycol and butyl carbitol. In other embodiments the one or more organic solvents comprise propylene glycol and butyl carbitol. In still other embodiments, the one or more organic solvents comprise butyl carbitol and propylene glycol n-butyl ether (PnB). By way of further example, the one or more organic solvents may comprise propylene glycol n-butyl ether (PnB) and butyl glycol or may comprise butyl carbitol and butyl glycol.

Typically, the total proportion of solvents is at least about 2 wt %, at least about 5 wt %, at least about 10 wt %, at least about 15 wt %, at least about 20 wt %, or at least about 25 wt %.

For example, in certain embodiments the total proportion of organic solvents is from about 5 wt % to about 30 wt %, from about 5 wt % to about 15 wt %, or from about 2 wt % to about 15 wt %.

In accordance with the invention, it has been discovered that solvents have different effects on the surfactant also present invention composition, as detailed in the following Examples. In certain embodiments, therefore, the solvent(s) are selected and formulated in proportions that provide a foam concentrate with a viscosity that is less heat-thinning. Thus, various compositions of the present invention include a concentrate heat-thinning solvent blend comprising one or more glycol solvents and/or one or more glycol ether solvents.

Surfactant(s)

The surfactant component of the compositions of the present invention generally includes one or more anionic surfactants and one or more amphoteric surfactants.

Suitable anionic surfactants include C8-C22 sulfonate surfactants, C8-C22 sulfate surfactants and branched and/or linear ethoxylated C8-C16 sulfate surfactants.

In certain embodiments, C8-C22 sulfonate surfactant or C8-C22 sulfate surfactant is the lone anionic surfactant. In other embodiments, both a C8-C22 sulfonate surfactant or C8-C22 sulfate surfactant and a branched and/or linear ethoxylated sulfate C8-C16 sulfate surfactant is also included.

Any C8-C22 sulfonate surfactant or C8-C22 sulfate surfactant is typically included in a concentration of from about 0.5 wt % to about 10 wt % (e.g., from about 0.5 wt % to about 7 wt %), from about 1 wt % to about 10 wt %, or from about 1 wt % to about 9 wt %.

Any branched and/or linear ethoxylated C8-C16 sulfate surfactant is typically present in a concentration of from about 1 wt % to about 10 wt % (e.g., about 1 wt % to about 8 wt %) or from about 5 wt % to about 20 wt %.

Suitable amphoteric surfactants include C8-C22 betaine surfactants and C8-C22 sultaine surfactants. Suitable betaine surfactants include C10-C16, C12-C14, and C12 betaine surfactants. Suitable sultaine surfactants include C10-C16, C12-C14, and C12 sultaine surfactants.

Any C8-C22 betaine surfactant is typically included in a concentration of from about 2 wt % to about 25 wt %, from about from about 2 wt % to about 20 wt %, from about 2 wt % to about 15 wt %, or from about 2 wt % to about 12 wt %.

Any C8-C22 sultaine surfactant is typically included in a concentration of from about 2 wt % to about 25 wt %, from about from about 2 wt % to about 20 wt %, from about 2 wt % to about 15 wt %, or from about 2 wt % to about 12 wt %.

Suitable amphoteric surfactants include C8-C22 betaine surfactants and C8-C22 sultaine surfactants.

In various embodiments, the surfactant component includes a C8-C22 sulfonate surfactant or C8-C22 sulfate surfactant, a branched and/or linear ethoxylated sulfate C8-C16 sulfate surfactant, a C8-C22 betaine surfactant, and a C8-C22 sultaine surfactant. In accordance with the present it has been discovered that compositions including such a surfactant component pass both UL and FM sprinkler fire tests for polar and nonpolar fuels.

Alcohol(s)

Suitable alcohols for use in the compositions of the present invention include linear alcohols (e.g., C8-C16 linear alcohols), branched alcohols (e.g., C10-C16 branched alcohols), and combinations thereof. Typically, any linear alcohol, branched alcohol, or combination thereof is present in a concentration of from about 0.3 wt % to about 0.25 wt %, or from about 0.3 wt % to about 2.0 wt %.

It has been discovered that incorporating a branched alcohol, alone or in combination with a linear alcohol, provides improved foam performance in terms of increased foam expansion, extended foam life, and increased isopropyl alcohol (IPA) resistance. Thus, various embodiments of the present invention comprise a foam-enhancing alcohol component comprising a branched alcohol.

Biopolymer(s)

The compositions of the present invention also typically include a biopolymer component. The biopolymer component may include one or more (e.g., two or three) biopolymers with the overall biopolymer component typically present in a concentration of from about 0.2 wt % to about 20 wt %.

Suitable biopolymers include alginate, acacia, agar, carrageenan, gellan gum, guar gum, inulin, konjac, locust bean gum, pectin, tara gum, alginate, carboxymethylcellulose (CMC), xanthan, carrageenan, diutan gum, gellan gum, locust bean gum, scleroglucan, chitin, modified guar gum, casein, welan gum, and combinations thereof.

In various embodiments, the biopolymer is selected from the group consisting of diutan gum, xanthan, guar gum, welan gum, gellan gum, and combinations thereof.

Further in accordance with the present invention it has been discovered that incorporation of a short-chain surfactant and adjusting the alcohol by adding a branched alcohol may adjust the biopolymer hydration behavior. Specifically, these chemicals may decrease biopolymer hydration at low temperature, which reduces the flow resistance curing cold temperature proportioning (CPT) testing and can lower the freezing point.

Thus, certain embodiments of the present invention comprise a short chain surfactant and a branched alcohol.

The compositions of the present invention are typically in the form of a concentrate and provided in equipment suitable for generation of foam. Suitable foam generating equipment includes aspirated foam generating devices, non-aspirated foam generating devices foam chambers, and sprinkler systems, in particular for use in a variety of sprinkler systems, including multi-head sprinkler systems.

The foams of the present invention are particularly suitable for use in sprinklers in commercial or industrial settings, including warehouses and for use in the chemical and petroleum industries.

Further in accordance with the present invention, the firefighting foam concentrates are currently believed to be multipurpose 3×3 (a proportioning rate of 3% for use with both hydrocarbons and polar solvents) fluorine-free foam concentrates that meet UL and FM standards,

The compositions and foams of the present invention are suitable for use in methods for combatting and/or extinguishing a Class-B fire where a composition or foam composition is applied directly or indirectly onto a Class-B fire.

Having described the invention in detail, it will be apparent that modifications and variations are possible without departing from the scope of the invention defined in the appended claims.

### EXAMPLES

The following non-limiting examples are provided to further illustrate the present invention.

### Example 1

Following are various testing results for the fluorine-free compositions described in the following table.

TABLE 1
Compositions for fluorine free 3 × 3 products

| | | Formulation | Formulation | Formulation | Formulation | Formulation |
|---|---|---|---|---|---|---|
| Type | Composition | 1 | 2 | 3 | 4 | 5 |
| Solvent | Glycol and/or glycol | 5%-15% | 5%-15% | 5%-15% | 5-30% | 2%-15% |
| | ether | | | | | |
| | (1 to 3 solvents | | | | | |
| | added) | | | | | |
| Surfactant | Sulfonate/Sulfate | 1%-9% | 1%-9% | 0.5%-7% | 0.5-10% | 1%-10% |
| | Surfactant | | | | | |
| | (C8-C22) | | | | | |
| | Branched and Linear | 1%-8% | | 1-8% | 5-20% | 1%-10% |
| | Ethoxylated Sulfate | | | | | |
| | Surfactant | | | | | |
| | (C8-C16) | | | | | |
| | Betaine Surfactant | 2%-15% | 2%-25% | 2-12% | 2%-15% | 2%-20% |
| | (C8-C22) | | | | | |
| | Sultaine Surfactant | 2%-15% | 2%-25% | 2-12% | 2%-15% | 2%-20% |
| | (C8-C22) | | | | | |
| Alcohol | Linear alcohol | | 0.3%-2.0% | 0.3%-2.0% | 0.3%-2.0% | 0.3%-2.5% |
| | (C8-C16) | | | | | |
| | Branched alcohol | | | | | 0.3%-2.5% |
| | (C10-C16) | | | | | |
| | Linear and branched | | | | | 0.3%-2.5% |
| | alcohol | | | | | |
| Biopolymer | Biopolymer A | 0.2%-2.0% | 0.2%-2.0% | 0.2%-2.0% | 0.2%-2.0% | 0.2%-2.0% |
| | Biopolymer B | | 0.2%-2.0% | 0.2%-2.0% | | 0.2%-2.0% |
| | Biopolymer C | | | | 0.2%-2.0% | 0.2%-2.0% |

Surfactant Package Testing

The above formulations were tested for fire performance. As shown, the tested formulations (including hydrocarbon surfactants) pass both Underwriters Laboratory (UL) and Factory Mutual (FM) sprinkler fire tests for polar and nonpolar fuels.

TABLE 2
Fire performance

| Fire Test/Formulation | #1 | #2 | #3 | #4 | #5 |
|---|---|---|---|---|---|
| Sprinkler 11.2K | 3:00 | 3:04 | 2:29 | 2:32 | 2:15 |
| Heptane Extinguishment, min: s | | | | | |
| FM Sprinkler 11.2K | Self- | Failed torch | SE | Fail | SE |
| Heptane Burnback | extinguish | test | | Water | |
| | (SE) | | | deluge | |
| Sprinkler and Topside IPA | No IPA | Pass | Pass | Pass UL | Pass |
| Resistance | resistance | UL/FM | UL/FM | Sprinkler | UL&FM |
| | | topside | topside | | Sprinkler |
| Modifications | Baseline | Biopolymer, | Biopolymer, | Biopolymer, | Biopolymer, |
| | | solvent, | solvent, | solvent, | solvent, |
| | | alcohol | alcohol | alcohol | alcohol |
| Comment | Nonpolar fuel | Gain IPA | Both polar | Polar fuel | Both polar |
| | fire only | resistance | and | sprinkler | and |
| | | | nonpolar | fire only | nonpolar |
| | | | fuel fires | | fuel fires |

IPA = Isopropyl alcohol

Alcohol Screening

The following test results demonstrate how alcohols impact the foam expansion volume, drain time, and foam resistance to IPA. Alcohols (e.g., lauryl alcohol) are conventionally considered as defoamers. However, according to the following results when certain linear, branched, and/or a mixture of linear and branched alcohols are added to formulation #5, favorable effects on increasing foam expansion, extending foam lifetime, and improving IPA resistance are observed. Moreover, as shown above, formulation 5 also provides acceptable fire performance on polar fuel fires, which is currently believed to be due, at least in part, to biopolymer(s) and solvent(s) combination.

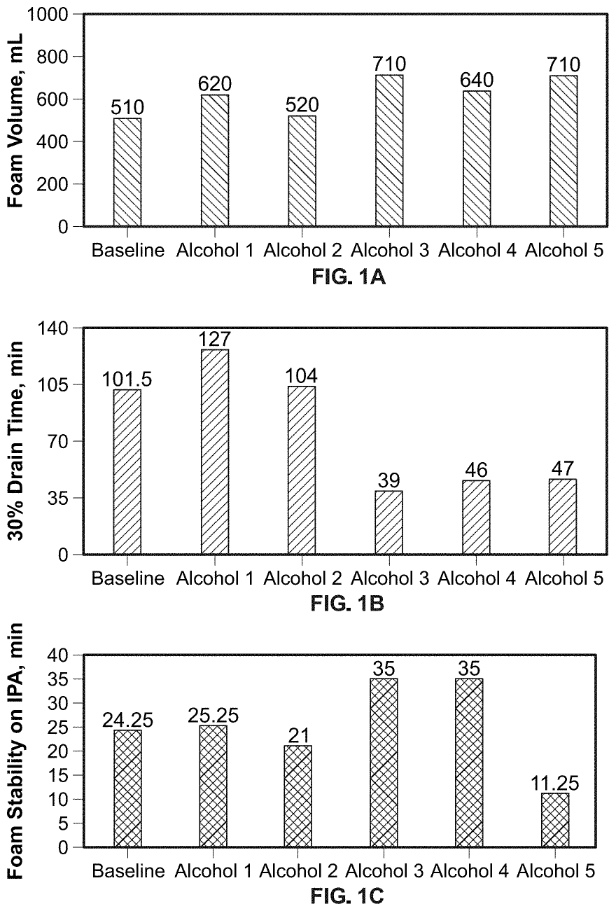

FIGS. 1A, 1B, and 1C display, respectively, the effects of different alcohols on (a) foam expansion volume out of 100 g 3% solution, (b) foam 30% drain time, and (c) foam stability on IPA for Formulation 5.

### Example 2

The following describes a novel methodology for controlling, or tuning the flow properties and stability of foam concentrates.

Most biopolymer-containing dispersion systems such as fluorine-free firefighting foams known in the art are heat-thinning (i.e., the system viscosity decreases with an increase in temperature). This property raises issues for the cold temperature proportioning (CTP) test for such system. In the CTP test, the results can be expressed as follows:

$$CTP = \frac{Cold temperature induction}{Normal temperature induction}$$

During listing and approval tests, it is required that the CTP value should be no smaller than 85%. The CTP results can be estimated based on the transformed Hagen-Poiseuille equation for laminar flow in the pipe,

$$Q = \frac{Δ p π {R}^{4}}{8 L} \times \frac{1}{μ}$$

Where,
p=pressure difference between the two ends
μ=dynamic viscosity
L=length of pipe
Q=volumetric flow rate
π=pi
R=pipe radius

To pass CTP tests, the foam concentration flow rate change needs to be within 15% between when tested at room temperature and when tested at minimum use temperature. Described herein are strategies for changing, controlling, or tuning viscosity dependence on temperature, thus enabling passing of the CTP test.

Solvent Blend Method

One method investigated involved blends of different solvents. In this study, it was found that the glycol and glycol ether solvents have different effects on biopolymer dispersion and hydration while mixing along with the surfactant packages used in the present compositions. Hence, the solvents are divided into two categories. When a solvent helps the biopolymer to disperse in the surfactant solution, it is called a dispersion (D) solvent. When a solvent helps the biopolymer to hydrate, it is called a hydration (H) solvent.

Without being bound to a particular theory, it is currently believed that the biopolymer morphology can be tuned by adjusting the dispersion and hydration solvent level. With proper hydration and adequate dispersion solvents, the biopolymer cross-linked structure can be reduced thus making the foam concentrate viscosity less heat-thinning.

TABLE 3
Solvent categories in the solvent-blend method

| | Dispersion | Hydration |
|---|---|---|
| Solvent/Function | [symbol] | [symbol] |
| 1 | D | H |
| 2 | D | |
| 3 | D | |
| 4 | | H |
| 5 | | H |
| 6 | | H |
| 7 | | H |

TABLE 4
Modifications of Formulation 3 based on solvent-blend method

| Solvent/Formulation | 3 | 3-A | 3-B | 3-C |
|---|---|---|---|---|
| 3 | | | | |
| 1 | + | | + | + |
| 3 | | + | + | |
| 6 | | + | | + |
| 7 | | | + | |
| CTP | 59% | 86% | 95% | 83% |

Table 4 shows modifications to Formulation 3 from Table 1 above (containing a linear alcohol) with blending of dispersion and hydration solvents. As shown, with blending of solvents having dispersion or hydration effects, the CTP test results can be increased from 59% (fail) to up to 86% or even 95% (both passing). These results validate the hypothesis of the blend-solvent method. More rheological behavior testing was collected to support the hypothesis, as shown below.

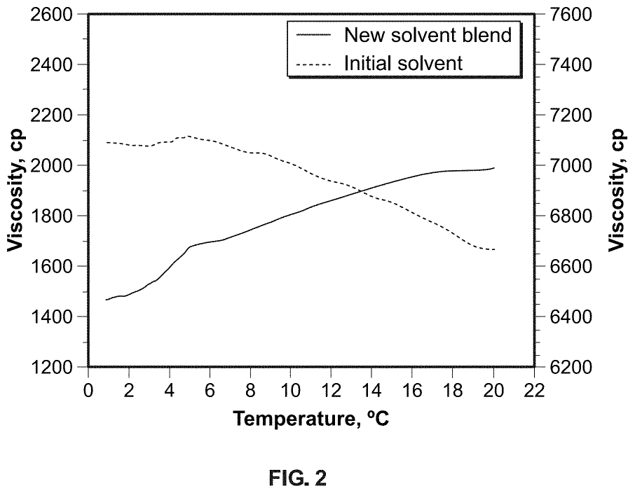

For the results displayed in FIG. 2, the viscosity data are collected at a shear rate of 5 s⁻¹. The only variable between the two samples is the solvent combination. FIG. 2 displays results for Formulation 3 (Initial solvent(s)) and 3B (New solvent-blend) FIG. 2 displays an example of converting a heat-thinning foam concentrate to a heat-thickening solvent using the solvent-blend method. The adjustment in solvents for Formulation 3 converted the concentrate from a heat-thinning liquid (i.e., the system viscosity decreases with an increase in temperature) to a heat-thickening liquid (e.g., one passing the CTP testing at percentage of greater than 85%). Referring to Hagen-Poiseuille equation, the lower viscosity at low temperature is favorable for the sample to pass the CTP test.

Additional Methods for Flow Property Control

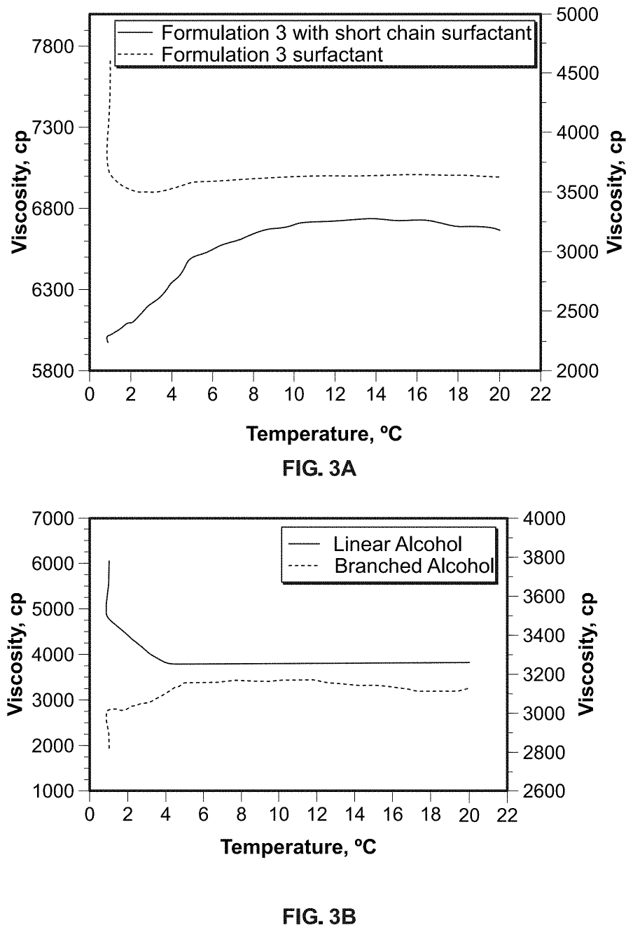

As depicted in FIGS. 3A and 3B, the biopolymer hydration behavior as a function of temperature can also be converted by adding a short-chain surfactant and changing the alcohol structures. Without being bound to any particular theory, it is currently believed that the “triggering chemicals” (i.e., the short-chain surfactant and/or the alcohols) can improve the foam concentration in either or both of two aspects: 1) they can decrease the biopolymer hydration at low temperature which cuts the flow resistance during the CTP test, and/or 2) they can lower the freezing point.

FIG. 3A shows the results of converting a heat-thinning foam concentrate to a heat-thickening foam concentrate by adding short chain surfactants. FIG. 3B shows the results of converting a heat-thinning foam concentrate to a heat-thickening foam concentrate by changing the alcohol structure.

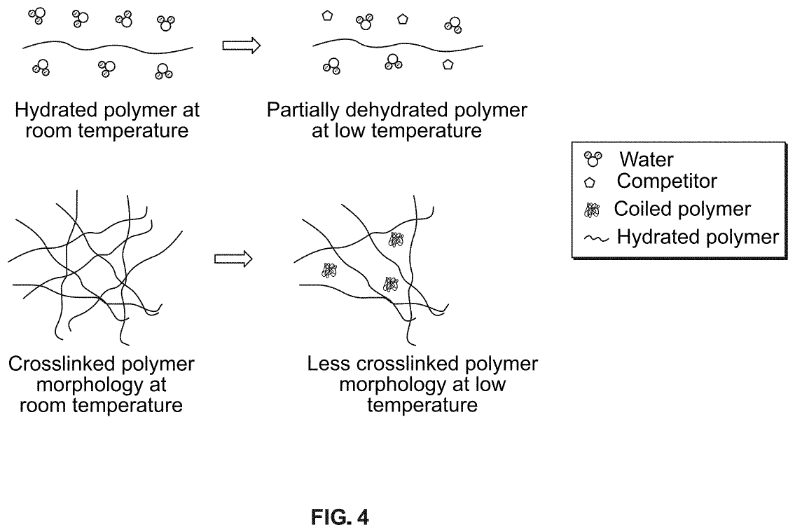

A proposed mechanism for modifying the foam concentrate flow properties is displayed in FIG. 4. At room temperature, the proper hydration uncoils the biopolymer, thus the foam concentration exhibits high viscosity due to the cross-linked structure. At low temperatures, e.g., between 1° C. and 4° C., the biopolymer starts to dehydrate, and the solution exhibits lower flow resistance. Without being bound to a particular theory, it is currently believed and proposed that the dehydration process at low temperatures is caused by the competitive adsorption onto the biopolymer between adsorbed water molecules and other, competitive molecules. In these data, the competitive molecules are solvent(s), short-chain surfactants, and alcohols.

Formulations Combining the Above Technologies for Commercial/Industrial Applications

By combining the results from the above testing, two formulations (5-A and 5-B) were made, which pass the polar and nonpolar sprinkler fire tests and exhibit advantageous flow properties according to the CTP test.

TABLE 5
Modifications of Formulation 5

| | UL/FM | UL/FM | | | | Stability |
|---|---|---|---|---|---|---|
| | Topside | Topside | | Heptane | IPA | At |
| Formulation | IPA | Heptane | CTP | Sprinkler | Sprinkler | 60° C. |
| 5-A | Pass, SE | Pass, SE | 93% | Pass FM | Pass FM | Stable |
| | | | | | | after |
| | | | | | | 65 days |
| 5-B | Pass, SE | Pass, SE | 92% | Pass | Pass | Stable |
| | | | | FM/UL | FM/UL | after |
| | | | | | | 65 days |

The detailed fire test results are listed in Table 6. Formulation 5-A meets FM standard 5130 for commercial/industrial applications.

TABLE 6
Formulation 5-A fire test summary as a FM product

| Formulation | 5-A | 5-A | 5-A | 5-A |
|---|---|---|---|---|
| Test type | FM | FM | UL | UL |
| Fuel | Sprinkler | Sprinkler | Topside | Topside |
| | Heptane | IPA | Heptane | IPA |
| Extinguishment | 2'23 | 4'09 | 1'10 | 3'20 |
| Time (min' sec) | | | | |
| Burnback (min' sec) | 6'30 | SE | SE | SE |
| Results | Pass | Pass | Pass | Pass |

Formulation 5-B was prepared by modifying the alcohol and solvent components of formulation 5-A. Formulation 5-B showed enhanced foam quality and performance during sprinkler fire tests (Table 7). Formulation 5-B meets both FM and UL standards for commercial/industrial applications, which includes both aspirated and non-aspirated sprinkler heads. Table 8 summarizes the overall sprinkler fire performance for formulation 5-A and 5-B.

TABLE 7
Formulation 5-B fire test summary as a FM and UL product

| Formulation 5-B | FM | FM | FM | UL | UL | UL | UL | UL | UL |
|---|---|---|---|---|---|---|---|---|---|
| Sprinkler head | 11.2K | 11.2K | 11.2K | 11.2K | 11.2K | 8.0K | 8.0K | 5.6K | 5.6K |
| | Pendant | Pendant | Upright | Pendant | Pendant | Pendant | Pendant | Pendant | Pendant |
| Fuel | Heptane | IPA | Heptane | Heptane | IPA | Heptane | IPA | Heptane | IPA |
| Test application | 0.3 | 0.4 | 0.3 | 0.2 | 0.3 | 0.14 | 0.25 | 0.1 | 0.3 |
| density, gpm/ft² | | | | | | | | | |
| Extinguishment Time | 2′15 | 4′03 | 2′27 | 2′08 | 2′55 | 2′15 | 3′43 | 2′40 | 1′15 |
| Burnback (BB) | SE | SE | SE | 6% at 9′ | SE | 5′05 | 5% at 9′ | 5′45 | SE |
| Results | Pass | Pass | Pass | Pass | Pass | Pass | Pass | Pass | Pass |

TABLE 8
Summary of sprinkler fires tests for Formulation 5-A and 5-B

| | | | UL Sprinkler | | | | FM Sprinkler | | | |
|---|---|---|---|---|---|---|---|---|---|---|
| | Sprinkler Head | | Heptane | IPA | PA | IPA | Heptane | Heptane | IPA | IPA |
| Formulation | Test/List Rate | | Min | 0.2/0 32 | 0.25/0.42 | 0.3/0.48 | 0.3 | 0.4 | 0.4 | 0.5 |
| 5-B | 11.2K | Pendant | [symbol] | | | [symbol] | [symbol] | | [symbol] | |
| 5-B | 11.2K | Upright | | | | | [symbol] | | | |
| 5-B | 8.0K | Pendant | [symbol] | | [symbol] | | | | | |
| 5-B | 8.0K | Upright | [symbol] | | | | | | | |
| 5-B | 5.6K | Pendant | [symbol] | | | [symbol] | | | | |
| 5-B | 5.6K | Upright | [symbol] | | [symbol] | | | | | |
| 5-A | 11.2K | Pendant | | | | | [symbol] | | [symbol] | |
| 5-A | 11.2K | Upright | | | | | [symbol] | | [symbol] | |

[symbol]

Pass [symbol]
Fail

As shown in Table 8, the only “Fail” test was for the combination of Formulation 5-A; Sprinkler Head Test/List Rate: 11.2K Upright; FM Sprinkler; Heptane 0.3.

In summary, the present invention includes hydrocarbon surfactant-based compositions developed for polar and nonpolar fuel fires. The claimed formulations are feasible for topside fires, and sprinkler fires with aspirated and non-aspirated sprinkler heads based on UL and FM standards.

The present invention also includes a new method for lowering the foam concentrate viscosity as temperature decreases. It is currently believed this behavior (i.e., the foam concentrate rheological changes at low temperatures) is explained by the competitive adsorption theory discussed above.

### EMBODIMENTS

For additional illustration, further and preferred embodiments of the present invention are set forth below.

Embodiment A is a firefighting foam concentrate, the concentrate comprising: one or more organic solvents, wherein the one or more organic solvents are selected from the group consisting of propylene glycol, glycerin, ethylene glycol, butyl carbitol, propylene glycol n-butyl ether (PnB), butyl glycol, polyethylene glycol, hexylene glycol, and combinations thereof; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, and combinations thereof; one or more alcohols; and one or more biopolymers, wherein the biopolymers constitute from about 0.2 wt % to about 2.0 wt % of the concentrate, and wherein the one or more solvents are selected to provide a heat thickening concentrate.

Embodiment B is a firefighting foam concentrate, the concentrate comprising: one or more organic solvents, wherein the one or more organic solvents are selected from glycols, glycol ethers, and combinations thereof; one or more surfactants, wherein the one or more surfactants comprise a C8-C22 sulfonate surfactant and/or a C8-C22 sulfate surfactant, a branched and/or linear ethoxylated sulfate C8-C16 sulfate surfactant, a C8-C22 betaine surfactant, and a C8-C22 sultaine surfactant; one or more alcohols; and one or more polymers, wherein the polymers constitute from about 0.2 wt % to about 2.0 wt % of the concentrate.

Embodiment C is a firefighting foam concentrate, the concentrate comprising: one or more organic solvents, wherein the one or more organic solvents are selected from glycols, glycol ethers, and combinations thereof; one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, and combinations thereof; one or more alcohols, wherein the one or more alcohols comprise at least one branched C10-C16 alcohol and the at least one branched C10-C16 alcohol constitutes from about 0.3 wt % to about 2.5 wt % of the concentrate; and one or more polymers, wherein the polymers constitute from about 0.2 wt % to about 2.0 wt % of the concentrate.

Embodiment D is a firefighting foam concentrate, the concentrate comprising: one or more organic solvents, wherein the one or more organic solvents are selected from the group consisting of propylene glycol, glycerin, ethylene glycol, butyl carbitol, propylene glycol n-butyl ether (PnB), butyl glycol, polyethylene glycol, hexylene glycol, and combinations thereof; one or more surfactants, wherein the one or more surfactants comprise a C8-C22 sulfonate surfactant or a C8-C22 sulfate surfactant, a branched and/or linear ethoxylated sulfate C8-C16 sulfate surfactants, a C8-C22 betaine surfactant, and a C8-C22 sultaine surfactant; one or more alcohols; and one or more biopolymers, wherein the one or more biopolymers are selected from the group consisting of diutan gum, xanthan, guar gum, welan gum, gellan gum, and combinations thereof, and wherein the concentrate passes the cold temperature proportioning (CTP) test. Embodiment D1 is the concentrate of any of the preceding Embodiments, wherein the one or more surfactants comprise a short chain surfactant selected from the group consisting of short chain sulfonate/sulfate surfactants, short chain branched and linear ethoxylated sulfate surfactants, short chain betaine surfactants, short chain sultaine surfactants, and combinations thereof.

Embodiment D2 is the concentrate of any of the preceding Embodiments, wherein the one or more solvents are selected from the group consisting of propylene, n-butyl glycol ether, dipropylene glycol n-propyl ether, dipropylene glycol n-butyl ether, propylene glycol n-butyl ether, propylene glycol n-propyl ether, tripropylene glycol n-butyl ether, propylene glycol phenyl ether, dipropylene glycol phenyl ether, dipropylene glycol dimethyl ether, propylene glycol methyl ether, propylene glycol methyl ether acetate, dipropylene glycol methyl ether, dipropylene glycol methyl ether acetate, tripropylene glycol methyl ether, ethylene glycol hexyl ether; diethylene glycol hexyl ether; ethylene glycol propyl ether; diethylene glycol phenyl ether, ethylene glycol phenyl ether, poly(oxy-1,2-ethanediyl), alphaphenyl-omegahydroxy, diethylene glycol ethyl ether, diethylene glycol n-butyl ether, ethylene glycol n-butyl ether, butyl carbitol, and combinations thereof.

Embodiment D3 is the concentrate of any of the preceding Embodiments wherein the one or more solvents are selected from the group consisting of from the group consisting of propylene glycol, hexylene glycol, butyl carbitol, propylene glycol n-butyl ether (PnB), butyl glycol, and combinations thereof.

Embodiment D4 is the concentrate of any of the preceding Embodiments wherein the one or more organic solvents comprise hexylene glycol and butyl carbitol.

Embodiment D5 is the concentrate of any of the preceding Embodiments wherein the one or more organic solvents comprise propylene glycol and butyl carbitol.

Embodiment D6 is the concentrate of any of the preceding Embodiments wherein the one or more organic solvents comprise butyl carbitol and propylene glycol n-butyl ether (PnB).

Embodiment D7 is the concentrate of any of the preceding Embodiments wherein the one or more organic solvents comprise propylene glycol n-butyl ether (PnB) and butyl glycol.

Embodiment D8 is the concentrate of any of the preceding Embodiments wherein the one or more organic solvents comprise butyl carbitol and butyl glycol.

Embodiment D9 is concentrate of any of the preceding Embodiments, wherein the one or more solvents constitute at least about 2 wt %, at least about 5 wt %, at least about 10 wt %, at least about 15 wt %, at least about 20 wt %, or at least about 25 wt % of the concentrate.

Embodiment D10 is the concentrate of any of the preceding Embodiments, wherein the one or more solvents constitute from about 5 wt % to about 30 wt %, from about 5 wt % to about 15 wt %, or from about 2 wt % to about 15 wt % of the concentrate.

Embodiment D11 is the concentrate of any of the preceding Embodiments, wherein the concentrate comprises a C8-C22 sulfonate surfactant and/or a C8-C22 sulfate surfactant at a concentration of from about 0.5 wt % to about 10 wt % (e.g., from about 0.5 wt % to about 7 wt %), from about 1 wt % to about 10 wt %, or from about 1 wt % to about 9 wt %.

Embodiment D12 is the concentrate of any of the preceding Embodiments, wherein the concentrate comprises a branched and/or linear ethoxylated C8-C16 sulfate surfactant at a concentration of from about 1 wt % to about 10 wt % (e.g., about 1 wt % to about 8 wt %) or from about 5 wt % to about 20 wt %.

Embodiment D13 is the concentrate of any of the preceding Embodiments, wherein the concentrate comprises a C8-C22 betaine surfactant at a concentration of from about 2 wt % to about 25 wt %, from about from about 2 wt % to about 20 wt %, from about 2 wt % to about 15 wt %, or from about 2 wt % to about 12 wt %.

Embodiment D14 is the concentrate of any of the preceding Embodiments, wherein the concentrate comprises a C10-C16 betaine surfactant at a concentration of from about 2 wt % to about 25 wt %, from about from about 2 wt % to about 20 wt %, from about 2 wt % to about 15 wt %, or from about 2 wt % to about 12 wt %.

Embodiment D15 is the concentrate of any of the preceding Embodiments, wherein the concentrate comprises a C8-C22 sultaine surfactant at a concentration of from about 2 wt % to about 25 wt %, from about from about 2 wt % to about 20 wt %, from about 2 wt % to about 15 wt %, or from about 2 wt % to about 12 wt %.

Embodiment D16 is the concentrate of any of the preceding Embodiments, wherein the concentrate comprises a C10-C16 sultaine surfactant at a concentration of from about 2 wt % to about 25 wt %, from about from about 2 wt % to about 20 wt %, from about 2 wt % to about 15 wt %, or from about 2 wt % to about 12 wt %.

Embodiment D17 is the concentrate of any of the preceding Embodiments, wherein the concentrate comprises a C8-C16 linear alcohol, a C10-C16 branched alcohol, or a combination thereof.

Embodiment D18 is the concentrate of any of the preceding Embodiments, wherein the one or more alcohols constitute from about 0.3 wt % to about 0.25 wt %, or from about 0.3 wt % to about 2.0 wt % of the concentrate.

Embodiment D19 is the concentrate of any of the preceding Embodiments, wherein the one or more biopolymers constitute from about 0.2 wt % to about 2.0 wt % of the concentrate.

Embodiment D20 is the concentrate of any of the preceding Embodiments, wherein the one or more biopolymers are selected from the group consisting of alginate, acacia, agar, carrageenan, gellan gum, guar gum, inulin, konjac, locust bean gum, pectin, tara gum, alginate, carboxymethylcellulose (CMC), xanthan, carrageenan, diutan gum, gellan gum, locust bean gum, scleroglucan, chitin, modified guar gum, casein, welan gum, and combinations thereof.

Embodiment E is a firefighting foam solution composition, the foam solution prepared by diluting any of the concentrates of the preceding Embodiments with water.

Embodiment F is a firefighting foam composition prepared from the any of the concentrates or solutions of the present Embodiments, wherein the foam composition: is suitable for use in aspirated and non-aspirated sprinkler heads; and/or meets FM standard 5130 for commercial/industrial applications; and/or meets both FM 5130 and UL 162 standards for commercial/industrial applications; and/or passes UL and/or FM topside polar and nonpolar fire tests; and/or passes UL/FM CTP test; and/or meets all stability requirements; and/or meets all sprinkler fire test requirements.

Embodiment G is directed to a method for controlling the viscosity of a firefighting foam concentrate, the method comprising: providing a foam concentrate of any of the preceding Embodiments; subjecting the foam concentrate to cold temperature proportioning (CTP) testing; determining whether the concentrate CTP testing results are above or below 85%; and if the CTP testing results are below 85%: adjusting the one or more solvents of the foam concentrate, wherein said adjusting comprises removing one or more of the solvents, adjusting the concentration of one or more of the solvents, and/or adding one or more solvents to the concentrate; and/or adding a short chain surfactant to the concentrate, wherein the short chain surfactant is selected from the group consisting of short chain sulfonate/sulfate surfactants, short chain branched and linear ethoxylated sulfate surfactants, short chain betaine surfactants, short chain sultaine surfactants, and combinations thereof; and/or adjusting the one or more alcohols, wherein said adjusting comprises removing the one or more alcohols and introducing one or more added alcohols, wherein the one or more added alcohols are different from the one or more alcohols and are selected from the group consisting of a C8-C16 linear alcohol, a C10-C16 branched alcohol, or a combination thereof.

Embodiment G1 is the method of Embodiment G wherein the one or more added solvents are selected from the group consisting of propylene glycol, glycerin, ethylene glycol, butyl carbitol, propylene glycol n-butyl ether, butyl glycol, polyethylene glycol, hexylene glycol, and combinations thereof.

Embodiment H is a firefighting foam concentrate, the concentrate comprising: one or more organic solvents selected from the group consisting of from the group consisting of propylene glycol, hexylene glycol, butyl carbitol, propylene glycol n-butyl ether (PnB), butyl glycol, and combinations thereof; one or more surfactants, wherein the one or more surfactants are selected from the group consisting of C8-C22 betaine surfactants, C8-C22 sultaine surfactants, and combinations thereof; one or more alcohols; and one or more biopolymers.

Embodiment H1 is the concentrate of Embodiment H wherein the one or more organic solvents comprise hexylene glycol and butyl carbitol; or propylene glycol and butyl carbitol; or butyl carbitol and propylene glycol n-butyl ether (PnB); or propylene glycol n-butyl ether (PnB) and butyl glycol; or butyl carbitol and butyl glycol.

Embodiment H2 is the concentrate of Embodiment H or H1 wherein the one or more surfactants comprises a C10-C16, C12-C14, and/or C12 betaine surfactant.

Embodiment H3 is the concentrate of any of Embodiments H to H2 wherein the one or more surfactants comprises a C10-C16, C12-C14, and/or C12 sultaine surfactant.

Example embodiments have been provided so that this disclosure will be thorough, and will fully convey the scope to those who are skilled in the art. Numerous specific details are set forth such as examples of specific components, methods, etc. to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes and well-known technologies are not described in detail.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, etc., these elements, components, etc. should not be limited by these terms. These terms may be only used to distinguish one element, component, etc. from another element, component, etc. Terms such as “first,” “second,” and other numerical terms when used herein do not imply a sequence or order unless clearly indicated by the context. Thus, a first element or component could be termed a second element or component without departing from the teachings of the example embodiments.

In view of the above, it will be seen that the several objects of the invention are achieved and other advantageous results attained.

As various changes could be made in the above without departing from the scope of the invention, it is intended that all matter contained in the above description and shown in the accompanying figures shall be interpreted as illustrative and not in a limiting sense.

Having described the present disclosure in detail, it will be apparent that modifications and variations are possible without departing from the scope of the present disclosure defined in the appended claims.

What is claimed is:

1. A firefighting foam concentrate, the concentrate comprising:
one or more organic solvents, wherein the one or more organic solvents are selected from the group consisting of propylene glycol, glycerin, ethylene glycol, butyl carbitol, propylene glycol n-butyl ether (PnB), butyl glycol, polyethylene glycol, hexylene glycol, and combinations thereof;
one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, and combinations thereof;
one or more alcohols; and
one or more biopolymers, wherein the biopolymers constitute from about 0.2 wt % to about 2.0 wt % of the concentrate, and wherein the one or more solvents are selected to provide a heat thickening concentrate.

2. A firefighting foam concentrate, the concentrate comprising:
one or more organic solvents, wherein the one or more organic solvents are selected from glycols, glycol ethers, and combinations thereof;
one or more surfactants, wherein the one or more surfactants comprise a C8-C22 sulfonate surfactant and/or a C8-C22 sulfate surfactant, a branched and/or linear ethoxylated sulfate C8-C16 sulfate surfactant, a C8-C22 betaine surfactant, and a C8-C22 sultaine surfactant;
one or more alcohols; and
one or more polymers, wherein the polymers constitute from about 0.2 wt % to about 2.0 wt % of the concentrate.

3. A firefighting foam concentrate, the concentrate comprising:
one or more organic solvents, wherein the one or more organic solvents are selected from glycols, glycol ethers, and combinations thereof;
one or more surfactants, wherein the one or more surfactants are selected from the group consisting of C8-C22 sulfonate surfactants, C8-C22 sulfate surfactants, branched and/or linear ethoxylated sulfate C8-C16 sulfate surfactants, C8-C22 betaine surfactants, C8-C22 sultaine surfactants, and combinations thereof;
one or more alcohols, wherein the one or more alcohols comprise at least one branched C10-C16 alcohol and the at least one branched C10-C16 alcohol constitutes from about 0.3 wt % to about 2.5 wt % of the concentrate; and
one or more polymers, wherein the polymers constitute from about 0.2 wt % to about 2.0 wt % of the concentrate.

4. A firefighting foam concentrate, the concentrate comprising:
one or more organic solvents, wherein the one or more organic solvents are selected from the group consisting of propylene glycol, glycerin, ethylene glycol, butyl carbitol, propylene glycol n-butyl ether (PnB), butyl glycol, polyethylene glycol, hexylene glycol, and combinations thereof;
one or more surfactants, wherein the one or more surfactants comprise a C8-C22 sulfonate surfactant or a C8-C22 sulfate surfactant, a branched and/or linear ethoxylated sulfate C8-C16 sulfate surfactants, a C8-C22 betaine surfactant, and a C8-C22 sultaine surfactant;
one or more alcohols; and
one or more biopolymers, wherein the one or more biopolymers are selected from the group consisting of diutan gum, xanthan, guar gum, welan gum, gellan gum, and combinations thereof, and wherein the concentrate passes the cold temperature proportioning (CTP) test.

5. The concentrate of claim 1, wherein the one or more surfactants comprise a short chain surfactant selected from the group consisting of short chain sulfonate/sulfate surfactants, short chain branched and linear ethoxylated sulfate surfactants, short chain betaine surfactants, short chain sultaine surfactants, and combinations thereof.

6. The concentrate of claim 2, wherein the one or more solvents are selected from the group consisting of propylene, n-butyl glycol ether, dipropylene glycol n-propyl ether, dipropylene glycol n-butyl ether, propylene glycol n-butyl ether, propylene glycol n-propyl ether, tripropylene glycol n-butyl ether, propylene glycol phenyl ether, dipropylene glycol phenyl ether, dipropylene glycol dimethyl ether, propylene glycol methyl ether, propylene glycol methyl ether acetate, dipropylene glycol methyl ether, dipropylene glycol methyl ether acetate, tripropylene glycol methyl ether, ethylene glycol hexyl ether; diethylene glycol hexyl ether; ethylene glycol propyl ether; diethylene glycol phenyl ether, ethylene glycol phenyl ether, poly(oxy-1,2-ethanediyl), alphaphenyl-omegahydroxy, diethylene glycol ethyl ether, diethylene glycol n-butyl ether, ethylene glycol n-butyl ether, butyl carbitol, and combinations thereof.

7. (canceled)

8. (canceled)

9. (canceled)

10. (canceled)

11. (canceled)

12. (canceled)

13. The concentrate of claim 1, wherein the one or more solvents constitute at least about 2 wt % of the concentrate.

14. The concentrate of claim 2, wherein the one or more solvents constitute from about 5 wt % to about 30 wt % of the concentrate.

15. The concentrate of claim 1, wherein the concentrate comprises a C8-C22 sulfonate surfactant and/or a C8-C22 sulfate surfactant at a concentration of from about 0.5 wt % to about 10 wt %.

16. The concentrate of claim 1, wherein the concentrate comprises a branched and/or linear ethoxylated C8-C16 sulfate surfactant at a concentration of from about 1 wt % to about 10 wt %.

17. The concentrate of claim 1, wherein the concentrate comprises a C8-C22 betaine surfactant at a concentration of from about 2 wt % to about 25 wt %.

18. The concentrate of claim 1, wherein the concentrate comprises a C10-C16 betaine surfactant at a concentration of from about 2 wt % to about 25 wt %.

19. The concentrate of claim 1, wherein the concentrate comprises a C8-C22 sultaine surfactant at a concentration of from about 2 wt % to about 25 wt %.

20. The concentrate of claim 1, wherein the concentrate comprises a C10-C16 sultaine surfactant at a concentration of from about 2 wt % to about 25 wt %.

21. The concentrate of claim 1, wherein the concentrate comprises a C8-C16 linear alcohol, a C10-C16 branched alcohol, or a combination thereof.

22. (canceled)

23. (canceled)

24. The concentrate of claim 2, wherein the one or more biopolymers are selected from the group consisting of alginate, acacia, agar, carrageenan, gellan gum, guar gum, inulin, konjac, locust bean gum, pectin, tara gum, alginate, carboxymethylcellulose (CMC), xanthan, carrageenan, diutan gum, gellan gum, locust bean gum, scleroglucan, chitin, modified guar gum, casein, welan gum, and combinations thereof.

25. A firefighting foam solution composition, the foam solution prepared by diluting the concentrate of claim 1 with water.

26. A firefighting foam composition prepared from the concentrate of claim 1, wherein the foam composition:
is suitable for use in aspirated and non-aspirated sprinkler heads; and/or
meets FM standard 5130 for commercial/industrial applications; and/or
meets both FM 5130 and UL 162 standards for commercial/industrial applications; and/or
passes UL and/or FM topside polar and nonpolar fire tests; and/or
passes UL/FM CTP test; and/or
meets all stability requirements; and/or
meets all sprinkler fire test requirements.

27. A method for controlling the viscosity of a firefighting foam concentrate, the method comprising:
providing a foam concentrate of claim 1;
subjecting the foam concentrate to cold temperature proportioning (CTP) testing;
determining whether the concentrate CTP testing results are above or below 85%; and
if the CTP testing results are below 85%:
adjusting the one or more solvents of the foam concentrate, wherein said adjusting comprises removing one or more of the solvents, adjusting the concentration of one or more of the solvents, and/or adding one or more solvents to the concentrate; and/or
adding a short chain surfactant to the concentrate, wherein the short chain surfactant is selected from the group consisting of short chain sulfonate/sulfate surfactants, short chain branched and linear ethoxylated sulfate surfactants, short chain betaine surfactants, short chain sultaine surfactants, and combinations thereof; and/or
adjusting the one or more alcohols, wherein said adjusting comprises removing the one or more alcohols and introducing one or more added alcohols, wherein the one or more added alcohols are different from the one or more alcohols and are selected from the group consisting of a C8-C16 linear alcohol, a C10-C16 branched alcohol, or a combination thereof

28. The method of claim 27 wherein the one or more added solvents are selected from the group consisting of propylene glycol, glycerin, ethylene glycol, butyl carbitol, propylene glycol n-butyl ether, butyl glycol, polyethylene glycol, hexylene glycol, and combinations thereof.
